(19) United States
(12) Patent Application Publication
(10) Pub. No.: US 2019/0065191 A1
(43) Pub. Date: Feb. 28, 2019

(54) Apparatus and Methods for Vector Based Transcendental Functions

(71) Applicant: Cambricon Technologies Corporation Limited, Beijing (CN)

(72) Inventors: Dong Han, Beijing (CN); Xiao Zhang, Beijing (CN); Tianshi Chen, Beijing (CN); Yunji Chen, Beijing (CN)

(21) Appl. No.: 16/171,295

(22) Filed: Oct. 25, 2018

Related U.S. Application Data
(63) Continuation-in-part of application No. PCT/CN2016/081071, filed on May 5, 2016.

(30) Foreign Application Priority Data
Apr. 26, 2016 (CN) 201610266916.0

(51) Int. Cl. G06F 9/30; G06F 7/544; G06N 3/04

(52) U.S. Cl. CPC G06F 9/30036; G06N 3/04; G06F 9/3001; G06F 7/544

(57) ABSTRACT

Aspects for generating a dot product for two vectors in neural network are described herein. The aspects may include a controller unit configured to receive a transcendental function instruction that includes an address of a vector and an operation code that identifies a transcendental function. The aspects may further include a CORDIC processor configured to receive the vector that includes one or more elements based on the address of the vector in response to the transcendental function instruction. The CORDIC processor may be further configured to apply the transcendental function to each element of the vector to generate an output vector.

### CROSS-REFERENCE TO RELATED APPLICATIONS

The present invention is a continuation-in-part of PCT Application No. PCT/CN2016/081071, filed on May 5, 2016, which claims priority to commonly owned CN Application No. 201610266916.0, filed on Apr. 26, 2016. The entire contents of each of the aforementioned applications are incorporated herein by reference.

### BACKGROUND

Transcendental function operations include but are not limited to exponential operations, logarithmic operations, and trigonometric function operations. The transcendental function operation is different from traditional four arithmetic operations and is not a finite polynomial. In the transcendental function operation, a relationship between variables cannot be expressed by a finite number of addition, subtraction, multiplication, division, power, and square, and therefore, computational difficulties and cost of the transcendental function operation far exceed that of the traditional four arithmetic operations. However, there are needs for performing some transcendental function operations on a whole column of vector data or even matrix data. For example, in many machine learning processes, exponential operations and logarithmic operations may be applied to a large amount of data. Therefore, it is desirable to provide an apparatus and method that can efficiently implement various transcendental function operations for vector data.

One of the most common solutions is to use a general-purpose processor to execute transcendental function operations on vectors. In this situation, a vector operation may be executed by executing a general-purpose instruction through a general-purpose register file and a universal function component. However, the general-purpose processor normally has no arithmetic component specifically for executing the transcendental function operation, and therefore a result of the transcendental function operation may be approximately approached by using high-order polynomials in the form of Taylor expansion. It may require multiple instructions to complete the entire operation. In addition, since the general-purpose processor is oriented to scalar operations, when implementing the transcendental function operation on the vector data, the vector data needs to be executed one by one, which further reduces the computational efficiency.

Conventionally, a graphics processing unit (GPU) may be used to execute the transcendental function operations on the vector data. In this situation, the transcendental function operation can be executed by executing a general-purpose single instruction multiple data (SIMD) instruction through the general-purpose register file and a general-purpose flow processing unit. With aid of this solution, although the problem of serial computing of the general-purpose processor described above can be solved, it still needs to use the Taylor expansion method to obtain high-precision results by using high-order polynomials. On the other hand, because on-chip cache of the GPU is too small, it is necessary to continuously move off-chip data when executing large-scale transcendental function operations. Therefore, an off-chip bandwidth will be a main trouble affecting the performance of the GPU.

As another conventional method, vector transcendental function operations can be executed with a special computing apparatus. Operations can be executed with a customized register file and a customized processing unit. However, limited by a design of the register file, the existing dedicated transcendental function operation apparatus is unable to flexibly support vector operations on data of different lengths.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example apparatus for neural network operations. The example apparatus may include a controller unit configured to receive a transcendental function instruction that indicates an address of a vector and an operation code that identifies a transcendental function. The example apparatus may further include a CORDIC processor configured to receive the vector that includes one or more elements based on the address of the vector in response to the transcendental function instruction. The CORDIC processor may be further configured to apply the transcendental function to each element of the vector to generate an output vector

Another example aspect of the present disclosure provides an example method for neural network operations. The example method may include receiving, by a controller unit, a transcendental function instruction that includes an address of a vector and an operation code that identifies a transcendental function; receiving, by a CORDIC processor, the vector that includes one or more elements based on the address of the vector in response to the transcendental function instruction, wherein the vector includes one or more elements; and applying, by the CORDIC processor, the transcendental function to each element of the vector to generate an output vector

To the accomplishment of the foregoing and related ends, the one or more aspects comprise the features herein after fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of an example neural network acceleration processor by which transcendental function computation may be implemented in a neural network;

FIG. 2 illustrates a block diagram of an example CORDIC processor by which transcendental function computation may be implemented in a neural network;

FIG. 3 illustrates a block diagram of an example CORDIC module by which transcendental function computation may be implemented in a neural network; and

FIG. 4 illustrates a flow chart of an example method for calculating transcendental function for a vector in a neural network.

### DETAILED DESCRIPTION

Various aspects are now described with reference to the drawings. In the following description, for purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or”, which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding to the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for clear and concise purpose, some known functionality and structure are not described. Besides, identical reference numbers refer to identical function and operation throughout the accompanying drawings.

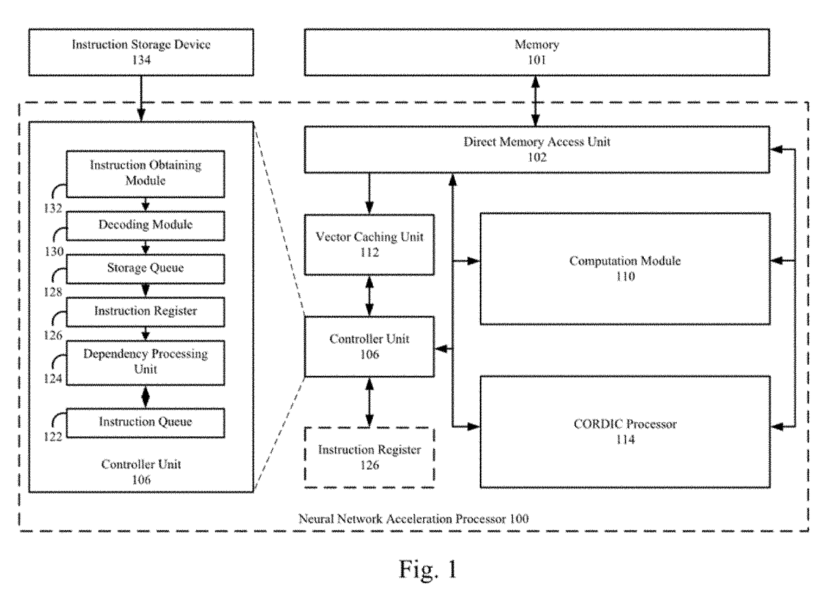

FIG. 1 illustrates a block diagram of an example neural network acceleration processor by which transcendental function computation may be implemented in a neural network.

As depicted, the example neural network acceleration processor 100 may include a controller unit 106, a direct memory access unit 102, a computation module 110, a vector caching unit 112, and a coordinate rotation digital computer (CORDIC) processor. Any of the above-mentioned components or devices may be implemented by a hardware circuit (e.g., application specific integrated circuit (ASIC), Coarse-grained reconfigurable architectures (CGRAs), field-programmable gate arrays (FPGAs), analog circuits, memristor, etc.).

In some examples, a vector operation instruction may originate from an instruction storage device 134 to the controller unit 106. An instruction obtaining module 132 may be configured to obtain a vector operation instruction from the instruction storage device 134 and transmit the instruction to a decoding module 130.

The decoding module 130 may be configured to decode the instruction. The instruction may include one or more operation fields that indicate parameters for executing the instruction. The parameters may refer to identification numbers of different registers (“register ID” hereinafter) in the instruction register 126. Thus, by modifying the parameters in the instruction register 126, the neural network acceleration processor 100 may modify the instruction without receiving new instructions. The decoded instruction may be transmitted by the decoding module 130 to an instruction queue module 128. In some other examples, the one or more operation fields may store immediate values such as addresses in the memory 101 and a scalar value, rather than the register IDs.

The instruction queue module 128 may be configured to temporarily store the received vector operation instruction and/or one or more previously received instructions. Further, the instruction queue module 128 may be configured to retrieve information according to the register IDs included in the vector operation instruction from the instruction register 126.

For example, the instruction queue module 128 may be configured to retrieve information corresponding to operation fields in the instruction from the instruction register 126. Information for the operation fields in a transcendental function instruction may include, for example, an address of a vector and a length of the vector. An operation code in the transcendental function instruction may indicate an operation to be performed to the identified vector.

As depicted, in some examples, the instruction register 126 may be implemented by one or more registers external to the controller unit 106. The instruction register 126 may be further configured to store scalar values for the instruction. Once the relevant values are retrieved, the instruction may be sent to a dependency processing unit 124.

The dependency processing unit 124 may be configured to determine whether the instruction has a dependency relationship with the data of the previous instruction that is being executed. This instruction may be stored in the storage queue module 122 until it has no dependency relationship on the data with the previous instruction that has not finished executing. If the dependency relationship does not exist, the controller unit 106 may be configured to decode one of the instructions into micro-instructions for controlling operations of other modules including the direct memory access unit 102 and the computation module 110.

In some examples, a transcendental function instruction may be one of an exponential operation instruction, a logarithmic operation instruction, a sinusoidal operation instruction, a cosine operation instruction, a tangent operation instruction, a cotangent operation instruction, an arcus sine operation instruction, an arcus cosine operation instruction, an arcus tangent operation instruction, or an arcus cotangent operation instruction.

For example, the controller unit 106 may receive an exponential operation (EXP) instruction that includes an address of a vector and a length of the vector. According to the EXP instruction, the direct memory access unit 102 may be configured to retrieve the vector starting from the included address in accordance with the length of the vector. The retrieved vector may be transmitted to and stored in the vector caching unit 112.

For example, the controller unit 106 may receive a logarithmic operation (LOG) instruction that includes an address of a vector and a length of the vector. According to the LOG instruction, the direct memory access unit 102 may be configured to retrieve the vector starting from the included address in accordance with the length of the vector. The retrieved vector may be transmitted to and stored in the vector caching unit 112.

For example, the controller unit 106 may receive a sinusoidal operation (SIN) instruction that includes an address of a vector and a length of the vector. According to the SIN instruction, the direct memory access unit 102 may be configured to retrieve the vector starting from the included address in accordance with the length of the vector. The retrieved vector may be transmitted to and stored in the vector caching unit 112.

For example, the controller unit 106 may receive a cosine operation (COS) instruction that includes an address of a vector and a length of the vector. According to the COS instruction, the direct memory access unit 102 may be configured to retrieve the vector starting from the included address in accordance with the length of the vector. The retrieved vector may be transmitted to and stored in the vector caching unit 112.

For example, the controller unit 106 may receive a tangent operation (TAN) instruction that includes an address of a vector and a length of the vector. According to the TAN instruction, the direct memory access unit 102 may be configured to retrieve the vector starting from the included address in accordance with the length of the vector. The retrieved vector may be transmitted to and stored in the vector caching unit 112.

For example, the controller unit 106 may receive a cotangent operation (COT) instruction that includes an address of a vector and a length of the vector. According to the COT instruction, the direct memory access unit 102 may be configured to retrieve the vector starting from the included address in accordance with the length of the vector. The retrieved vector may be transmitted to and stored in the vector caching unit 112.

For example, the controller unit 106 may receive an arcus sine operation (ARCSIN) instruction that includes an address of a vector and a length of the vector. According to the ARC SIN instruction, the direct memory access unit 102 may be configured to retrieve the vector starting from the included address in accordance with the length of the vector. The retrieved vector may be transmitted to and stored in the vector caching unit 112.

For example, the controller unit 106 may receive an arcus cosine operation (ARCCOS) instruction that includes an address of a vector and a length of the vector. According to the ARCCOS instruction, the direct memory access unit 102 may be configured to retrieve the vector starting from the included address in accordance with the length of the vector. The retrieved vector may be transmitted to and stored in the vector caching unit 112.

For example, the controller unit 106 may receive an arcus tangent operation (ARCTAN) instruction that includes an address of a vector and a length of the vector. According to the ARCTAN instruction, the direct memory access unit 102 may be configured to retrieve the vector starting from the included address in accordance with the length of the vector. The retrieved vector may be transmitted to and stored in the vector caching unit 112.

For example, the controller unit 106 may receive an arcus cotangent operation (ARCCOT) instruction that includes an address of a vector and a length of the vector. According to the ARCCOT instruction, the direct memory access unit 102 may be configured to retrieve the vector starting from the included address in accordance with the length of the vector. The retrieved vector may be transmitted to and stored in the vector caching unit 112.

The above mentioned instructions may be formatted as follows:

| Operation Code | Register 0 | Register 1 | Register 2 |
|---|---|---|---|
| EXP | An address | A length of | An address of an |
| | of a vector | the vector | output result |
| LOG | An address | A length of | An address of an |
| | of a vector | the vector | output result |
| SIN | An address | A length of | An address of an |
| | of a vector | the vector | output result |
| COS | An address | A length of | An address of an |
| | of a vector | the vector | output result |
| TAN | An address | A length of | An address of an |
| | of a vector | the vector | output result |
| COT | An address | A length of | An address of an |
| | of a vector | the vector | output result |
| ARCSIN | An address | A length of | An address of an |
| | of a vector | the vector | output result |
| ARCCOS | An address | A length of | An address of an |
| | of a vector | the vector | output result |
| ARCTAN | An address | A length of | An address of an |
| | of a vector | the vector | output result |
| ARCCOT | An address | A length of | An address of an |
| | of a vector | the vector | output result |

Hereinafter, a caching unit (e.g., the vector caching unit 112 etc.) may refer to an on-chip caching unit integrated in the neural network acceleration processor 100, rather than other storage devices in memory 101 or other external devices. In some examples, the on-chip caching unit may be implemented as a register file, an on-chip buffer, an on-chip Static Random Access Memory (SRAM), or other types of on-chip storage devices that may provide higher access speed than the external memory. In some other examples, the instruction register 126 may be implemented as a scratchpad memory, e.g., Dynamic random-access memory (DRAM), embedded DRAM (eDRAM), memristor, 3D-DRAM, non-volatile memory, etc.

Upon receiving an instruction, the controller unit 106 may be configured to first determine whether the instruction is a transcendental function instruction based on the operation code. If the instruction is a transcendental function instruction, the controller unit 106 may be configured to transmit the instruction to the CORDIC processor 114. If the instruction is not a transcendental function instruction, the controller unit 106 may be configured to transmit the instruction to the computation module 110.

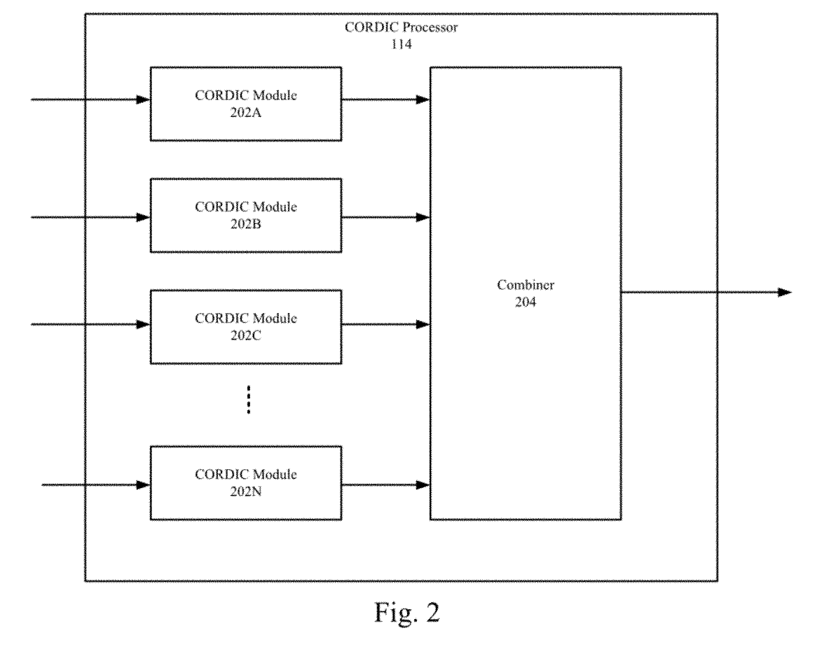

FIG. 2 illustrates a block diagram of an example CORDIC processor 114 by which transcendental function computation may be implemented in a neural network.

As depicted, the CORDIC processor 114 may include one or more CORDIC modules (collectively CORDIC modules 202). Each of the CORDIC modules 202 may be configured to respectively process one element in the vector. The process results generated by the CORDIC modules 202 may be combined by the combiner 204 into an output vector.

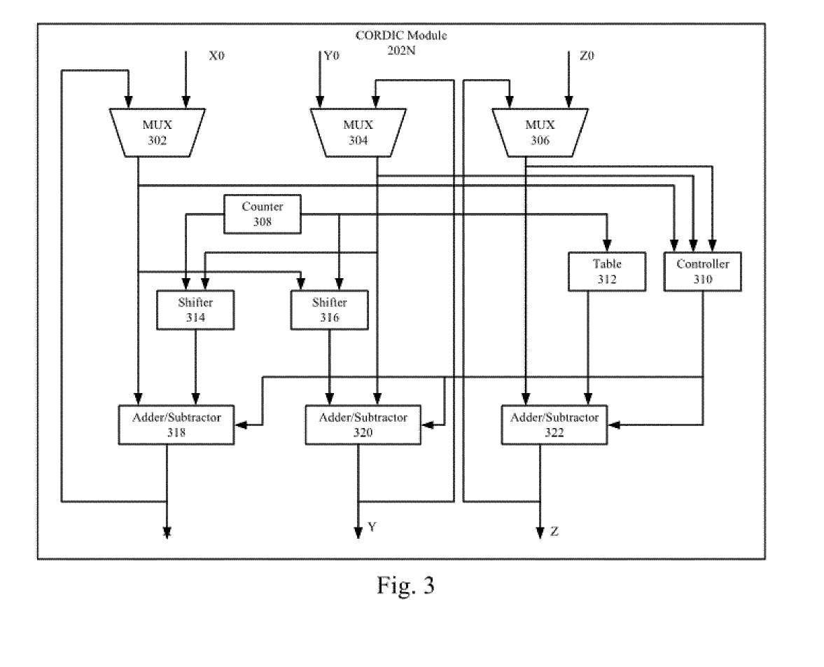

FIG. 3 illustrates a block diagram of an example CORDIC module by which transcendental function computation may be implemented in a neural network.

The example CORDIC module 202N may refer to a conventional FPCA based circuit that are described in the following articles: A survey of CORDIC algorithms for FPGA based computers, Ray Andraka; The CORDIC Computing Technique, Jack Volder; and CORDIC v6.0, LogiCORE IP Product Guide.

As depicted, the CORDIC module 202N may be configured to receive three initial values, e.g., X0, Y0, and Z0. A maximum repetition number for calculating the result of the transcendental function may be set. The maximum repetition number also may affect the accuracy of the result. The CORDIC module 202N may include three outputs, e.g., X, Y, and Z. Depending upon the operation code in the transcendental function instruction, the CORDIC module 202N may configure the initial values and the maximum repetition number.

A table showing the correspondence between the initial values and the outputs is provided here.

TABLE 1

| | | Initial values | | | Functions | |
|---|---|---|---|---|---|---|
| M | Mode | X0 | Y0 | Z0 | X | Y or Z |
| 1 | Rotation | 1 | 0 | θ | Cosθ | Y = Sinθ |
| −1 | Rotation | 1 | 0 | θ | Coshθ | Y = Sinhθ |
| −1 | Rotation | a | a | θ | ae^{θ} | Y = ae^{θ} |
| 1 | Vectoring | 1 | a | π/2 | \sqrt{a² + 1} | Z = cot⁻¹(a) |
| −1 | Vectoring | a | 1 | 0 | \sqrt{a² − 1} | Z = coth⁻¹(a) |
| −1 | Vectoring | a + 1 | a − 1 | 0 | 2\sqrt{a} | Z = 0.5ln(a) |
| −1 | Vectoring | a + ¼ | a − ¼ | 0 | \sqrt{a} | Z = ln(a/4) |
| −1 | Vectoring | a + b | a − b | 0 | 2 \sqrt{ab} | Z = 0.5ln(a/b) |

According to the table above, the CORDIC module 202N may be configured to adjust the initial values based on the transcendental function specified in the transcendental function instruction to generate a process result.

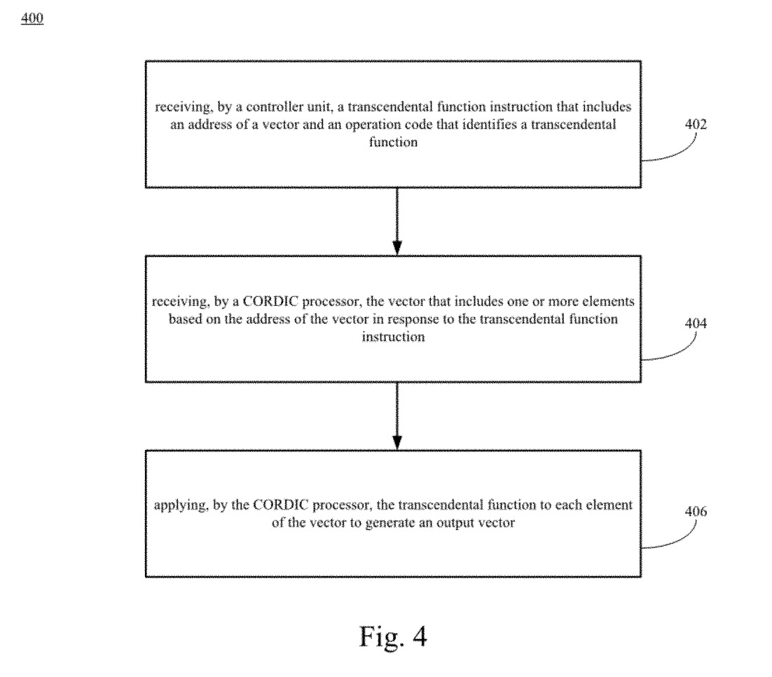

FIG. 4 illustrates a flow chart of an example method 400 for calculating transcendental function for a vector in a neural network. The example method 400 may be performed by one or more components described in FIGS. 1-3.

At block 402, the example method 400 may include receiving, by a controller unit, a transcendental function instruction that includes an address of a vector and an operation code that identifies a transcendental function. For example, the controller unit 106 may receive a transcendental function instruction that includes an address of a vector. The transcendental function instruction may further indicate a transcendental function to be preformed by the CORDIC processor 114.

At block 404, the example method 400 may include receiving, by a CORDIC processor, the vector that includes one or more elements based on the address of the vector in response to the transcendental function instruction, wherein the vector includes one or more elements. For example, the CORDIC processor 114 may receive a vector that includes one or more elements.

At block 406, the example method 400 may include applying, by the CORDIC processor, the transcendental function to each element of the vector to generate an output vector. For example, the CORDIC processor 114 may be configured to apply a transcendental function specified in the instruction to each element included in the vector to generate an output vector.

The process or method described in the above accompanying figures can be performed by process logic including hardware (for example, circuit, specific logic etc.), firmware, software (for example, a software being externalized in non-transitory computer-readable medium), or the combination of the above two. Although the process or method is described above in a certain order, it should be understood that some operations described may also be performed in different orders. In addition, some operations may be executed concurrently rather than in order.

In the above description, each embodiment of the present disclosure is illustrated with reference to certain illustrative embodiments. Apparently, various modifications may be made to each embodiment without going beyond the wider spirit and scope of the present disclosure presented by the affiliated claims. Correspondingly, the description and accompanying figures should be understood as illustration only rather than limitation. It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

We claim:

1. An apparatus for neural network operations, comprising:
a controller unit configured to receive a transcendental function instruction that indicates an address of a vector and an operation code that identifies a transcendental function; and
a CORDIC processor configured to receive the vector that includes one or more elements based on the address of the vector in response to the transcendental function instruction, wherein the CORDIC processor is further configured to apply the transcendental function to each element of the vector to generate an output vector.

2. The apparatus of claim 1, wherein the transcendental function instruction includes one or more register IDs that identify one or more registers configured to store the address of the vector and the length of the vector.

3. The apparatus of claim 1,
wherein the transcendental function instruction further indicates a length of the vector, and
wherein the CORDIC processor is configured to retrieve the vector based on the length of the vector and the address of the vector.

4. The apparatus of claim 1, wherein the CORDIC processor includes one or more CORDIC modules respectively configured to apply the transcendental function to one of the one or more elements to generate a result.

5. The apparatus of claim 4,
wherein the transcendental function instruction is an exponential operation instruction, and
wherein each of the CORDIC modules is configured to perform an exponential operation to the elements respectively.

6. The apparatus of claim 4,
wherein the transcendental function instruction is a logarithmic operation instruction, and
wherein each of the CORDIC modules is configured to perform a logarithmic operation to the elements respectively.

7. The apparatus of claim 4,
wherein the transcendental function instruction is a sinusoidal operation instruction, and
wherein each of the CORDIC modules is configured to perform a sinusoidal operation to the elements respectively.

8. The apparatus of claim 4,
wherein the transcendental function instruction is a cosine operation instruction, and
wherein each of the CORDIC modules is configured to perform a cosine operation to the elements respectively.

9. The apparatus of claim 4,
wherein the transcendental function instruction is a tangent operation instruction, and
wherein each of the CORDIC modules is configured to perform a tangent operation to the elements respectively.

10. The apparatus of claim 4,
wherein the transcendental function instruction is a cotangent operation instruction, and
wherein each of the CORDIC modules is configured to perform a cotangent operation to the elements respectively.

11. The apparatus of claim 4,
wherein the transcendental function instruction is an arcus sine operation instruction, and
wherein each of the CORDIC modules is configured to perform an arcus sine operation to the elements respectively.

12. The apparatus of claim 4,
wherein the transcendental function instruction is an arcus cosine operation instruction, and
wherein each of the CORDIC modules is configured to perform an arcus cosine operation to the elements respectively.

13. The apparatus of claim 4,
wherein the transcendental function instruction is an arcus tangent operation instruction, and
wherein each of the CORDIC modules is configured to perform an arcus tangent operation to the elements respectively.

14. The apparatus of claim 4,
wherein the transcendental function instruction is an arcus cotangent operation instruction, and
wherein each of the CORDIC modules is configured to perform an arcus cotangent operation to the elements respectively.

15. The apparatus of claim 1, wherein the controller unit comprises an instruction obtaining module configured to obtain the transcendental function instruction from an instruction storage device.

16. The apparatus of claim 13, wherein the controller unit further comprises a decoding module configured to decode the transcendental function instruction into one or more micro-instructions.

17. The apparatus of claim 16, wherein the controller unit further comprises an instruction queue module configured to temporarily store the transcendental function instruction and one or more previously received instructions, and retrieve information corresponding to operation fields in the transcendental function instruction.

18. The apparatus of claim 17, wherein the controller unit further comprises an instruction register configured to store the information corresponding to the operation fields in the transcendental function instruction.

19. The apparatus of claim 18, wherein the controller unit further comprises a dependency processing unit configured to determine whether transcendental function instruction has a dependency relationship with the one or more previously received instructions.

20. The apparatus of claim 19, wherein the controller unit further comprises a storage queue module configured to store the transcendental function instruction while the dependency processing unit is determining whether the transcendental function instruction has the dependency relationship with the one or more previously received instructions.

21. A method for neural network operations, comprising:
receiving, by a controller unit, a transcendental function instruction that includes an address of a vector and an operation code that identifies a transcendental function;
receiving, by a CORDIC processor, the vector that includes one or more elements based on the address of the vector in response to the transcendental function instruction; and
applying, by the CORDIC processor, the transcendental function to each element of the vector to generate an output vector.

22. The method of claim 21, wherein the transcendental function instruction includes one or more register IDs that identify one or more registers configured to store the address of the vector and the length of the vector.

23. The method of claim 21,
wherein the transcendental function instruction further indicates a length of the vector, and
wherein the CORDIC processor is configured to retrieve the vector based on the length of the vector and the address of the vector.

24. The method of claim 21, wherein the applying the transcendental function further comprises respectively applying, by one or more CORDIC modules of the CORDIC processor, the transcendental function to one of the one or more elements to generate a result.

25. The method of claim 24, wherein the applying further comprises performing, by each of the CORDIC modules, an exponential operation to the elements respectively when the transcendental function instruction is an exponential operation instruction.

26. The method of claim 24, wherein the applying further comprises performing, by each of the CORDIC modules, a logarithmic operation to the elements respectively when the transcendental function instruction is a logarithmic operation instruction.

27. The method of claim 24, wherein the applying further comprises performing, by each of the CORDIC modules, a sinusoidal operation to the elements respectively when the transcendental function instruction is a sinusoidal operation instruction.

28. The method of claim 24, wherein the applying further comprises performing, by each of the CORDIC modules, a cosine operation to the elements respectively when the transcendental function instruction is a cosine operation instruction.

29. The method of claim 24, wherein the applying further comprises performing, by each of the CORDIC modules, a tangent operation to the elements respectively when the transcendental function instruction is a tangent operation instruction.

30. The method of claim 24, wherein the applying further comprises performing, by each of the CORDIC modules, a cotangent operation to the elements respectively when the transcendental function instruction is a cotangent operation instruction.

31. The method of claim 24, wherein the applying further comprises performing, by each of the CORDIC modules, an arcus sine operation to the elements respectively when the transcendental function instruction is an arcus sine operation instruction.

32. The method of claim 24, wherein the applying further comprises performing, by each of the CORDIC modules, an arcus cosine operation to the elements respectively when the transcendental function instruction is an arcus cosine operation instruction.

33. The method of claim 24, wherein the applying further comprises performing, by each of the CORDIC modules, an arcus tangent operation to the elements respectively when the transcendental function instruction is an arcus tangent operation instruction.

34. The method of claim 24, wherein the applying further comprises performing, by each of the CORDIC modules, an arcus cotangent operation to the elements respectively when the transcendental function instruction is an arcus cotangent operation instruction.

35. The method of claim 21, further comprising obtaining, by an instruction obtaining module of the controller unit, the transcendental function instruction from an instruction storage device.

36. The method of claim 35, further comprising decoding, by a decoding module of the controller unit, the transcendental function instruction into one or more micro-instructions.

37. The method of claim 36, further comprising temporarily storing, by an instruction queue module of the controller unit, the transcendental function instruction and one or more previously received instructions, and retrieve information corresponding to operation fields in the transcendental function instruction.

38. The method of claim 37, further comprising storing, by an instruction register of the controller unit, the information corresponding to the operation fields in the transcendental function instruction.

39. The method of claim 38, further comprising determining, by a dependency processing unit of the controller unit, whether the transcendental function instruction has a dependency relationship with the one or more previously received instructions.

40. The method of claim 39, further comprising storing, by a storage queue module of the controller unit, the transcendental function instruction while the dependency processing unit is determining whether the transcendental function instruction has the dependency relationship with the one or more previously received instructions.
